(19) United States
(12) Patent Application Publication
(10) Pub. No.: US 2026/0252427 A1
(43) Pub. Date: Aug. 27, 2026

(54) FAILURE INFORMATION PROCESSING SYSTEM AND METHOD FOR ISSUE CLASSIFICATION OF STORAGE DEVICES

(71) Applicant: SK hynix Inc., Gyeonggi-do (KR)

(72) Inventor: Uladzislau KAZLOUSKI, Gdansk (PL)

(21) Appl. No.: 19/066,055

(22) Filed: Feb. 27, 2025

(51) Int. Cl. G06F 11/07; G06F 40/216

(52) U.S. Cl. CPC G06F 11/0769; G06F 11/0727

(57) ABSTRACT

A system for processing failure information for storage devices includes: a preprocessor configured to process test failure information to generate text, categorical and numerical features, the test failure information associated with test failures for a storage device; an embedding vector generator configured to generate an embedding vector based on the text features; a features concatenator configured to concatenate the embedding vector and the categorical and numerical features, and generate concatenated features as a training dataset; and a classifier configured to classify the training dataset, and generate prediction information indicating probabilities for each category identifying features to change for a reduction in the test failures in the storage device.

### BACKGROUND

### 1. Field

Embodiments of the present disclosure relate to a scheme for processing failure information for a storage device.

### 2. Description of the Related Art

Modern storage devices such as solid state drives (SSD) are sophisticated products that require expertise on different levels of development. This expertise includes protocols, flash memory management, controller design, firmware (FW) development etc. All expertise may be gathered from different teams creating a final SSD product.

During the development of a SSD, changes made and upcoming changes can be tracked as well as validation results. While a process of recording changes is simplified by issue trackers (e.g., Jira™ an issue tracking tool commercially available from Atlassian Pty Ltd of Sydney, Australia), a process of assigning a new issue to the correct team and team member(s) still requires manual work, knowledge of team's responsibilities and understanding of the issue(s). With the latest advancements in large language models, the manual work activity can be done automatically, saving time and human resources. However, existing approaches are limited. For example, some approaches often use only textual information (features). In addition to textual information, domain specific categorical and numerical values (features) are needed for tasks with a high level of prior knowledge and diverse issues.

It is in this context that embodiments of the invention arise.

### SUMMARY

Aspects of the present invention include a system and a method for processing failure information for issue classification of a storage device.

In one aspect of the present invention, a system for processing failure information for storage devices includes: a preprocessor configured to process test failure information to generate text, categorical and numerical features, the test failure information associated with test failures for a storage device; an embedding vector generator configured to generate an embedding vector based on the text features; a features concatenator configured to concatenate the embedding vector and the categorical and numerical features, and generate concatenated features as a training dataset; and a classifier configured to classify the training dataset, and generate prediction information indicating probabilities for each category affecting the test failures, the probabilities for each category identifying features to change for a reduction in the test failures in the storage device.

In one aspect of the present invention, a method for processing failure information for storage devices includes: processing test failure information to generate text, categorical and numerical features, the test failure information associated with test failures for a storage device; generating an embedding vector based on the text features; concatenating the embedding vector and the categorical and numerical features to generate concatenated features as a training dataset; and classifying the training dataset to generate prediction information indicating probabilities for each category affecting the test failures, the probabilities for each category identifying features to change for a reduction in the test failures in the storage device.

Additional aspects of the present invention will become apparent from the following description.

### BRIEF DESCRIPTION OF THE DRAWINGS

FIG. 1 is a diagram illustrating a failure processing system for issue classification of storage devices in accordance with one embodiment of the present invention.

FIG. 2 is a diagram illustrating a failure information providing apparatus in accordance with one embodiment of the present invention.

FIG. 3 is a diagram illustrating a prediction and explanation system in accordance with one embodiment of the present invention.

FIG. 4 is a diagram of a neural network in accordance with one embodiment of the present invention.

FIG. 5 is a block diagram of stacked models in accordance with one embodiment of the present invention.

FIG. 6 illustrates an example of text features in accordance with one embodiment of the present invention.

FIG. 7 illustrates an example of JavaScript Object Notation features in accordance with one embodiment of the present invention.

FIG. 8 illustrates an example of one-hot encoded labels in accordance with one embodiment of the present invention.

FIG. 9 illustrates an example of additional message flags in accordance with one embodiment of the present invention.

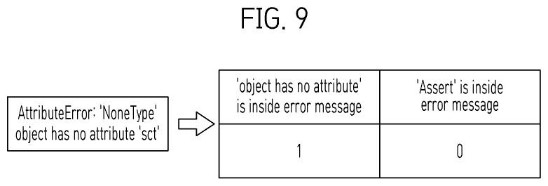

FIG. 10 illustrates a distribution of an accuracy of a prediction and explanation system in accordance with one embodiment of the present invention.

FIG. 11 illustrates aggregated importance of numerical features in a prediction and explanation system in accordance with one embodiment of the present invention.

FIG. 12 illustrates importance of text tokens for Team 1 class in a prediction and explanation system in accordance with one embodiment of the present invention.

FIG. 13 is a flowchart illustrating a failure processing method for issue classification of storage devices in accordance with one embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of the embodiments of the present invention is provided below along with accompanying figures that illustrate aspects of the present invention. The present invention is described in connection with such embodiments, but the present invention is not limited to any embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention may not have been described in detail.

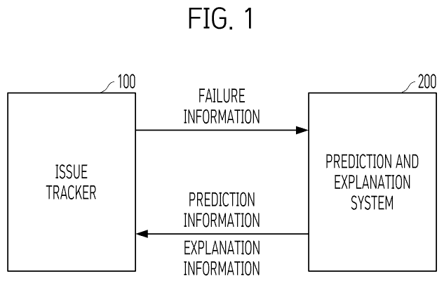

FIG. 1 is a diagram illustrating a failure processing system for issue classification of storage devices in accordance with one embodiment of the present invention. The failure processing system shown in FIG. 1 may be implemented for storage devices such as NAND flash memory devices, e.g., Solid State Drive (SSD), Embedded MultiMedia Card (eMMC), Open NAND Flash Interface (ONFi), Universal Flash Storage (UFS), a low-power Mobile Industry Processor Interface (MIPI) Physical Layer (M-PHY), Non-Volatile Memory express (NVMe), etc.

Referring to FIG. 1, the failure processing system may include an issue tracker 100 and a prediction and explanation system 200. The issue tracker 100 may keep track of changes made and upcoming changes as well as validation results, which may be collected from several teams during the development of storage devices. In some embodiments, the issue tracker 100 may be implemented with a particular tool such as Jira™. Jira™ is a project management software management tool that allows issue tracking, bug tracking and agile project management for project, time, requirements, task, bug, change, code, test, release, etc. The issue tracker may be referred to as other equivalent elements for performing the same or similar functions and operations.

The issue tracker 100 may output failure information associated with issues during the development of storage devices. The prediction and explanation system 200 may receive the failure information, and perform prediction and explanation based on the failure information, and therefrom generate prediction information and explanation information. The prediction information and explanation information may be provided to the issue tracker 100.

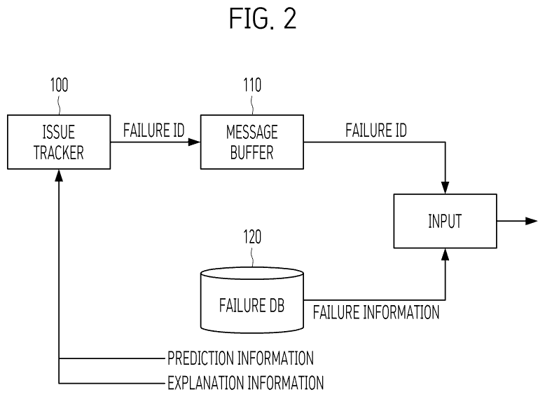

FIG. 2 is a diagram illustrating a failure information providing apparatus in accordance with one embodiment of the present invention.

Referring to FIG. 2, the failure information providing apparatus may include the issue tracker 100, a message buffer 110 and a failure database (DB) 120. The issue tracker 100 may output failure identifier (ID). The message buffer 110 may buffer (store) the failure ID and output the stored failure ID. The failure DB 120 may output failure information corresponding to the failure ID to the prediction and explanation system 200 of FIG. 1. As such, the test failure information may be retrieved from the failure DB 120 in response to the failure ID received from the issue tracker 100.

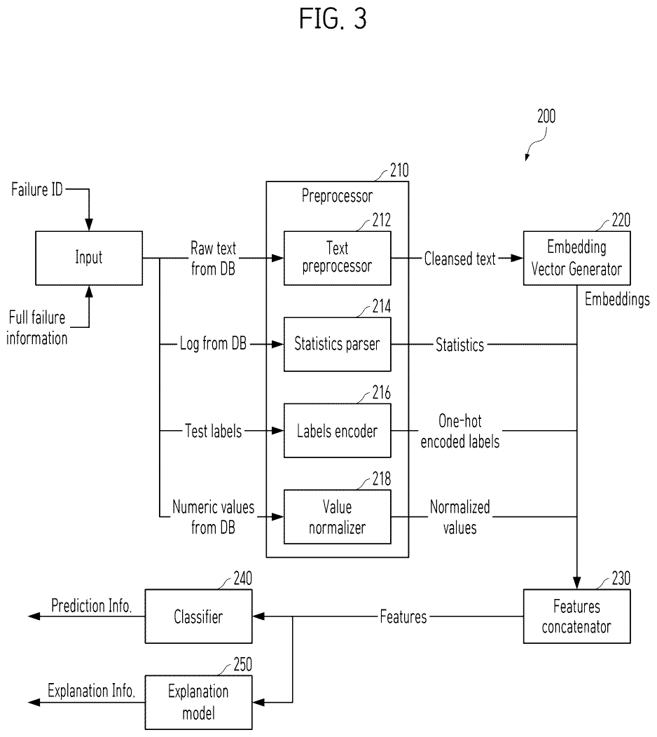

FIG. 3 is a diagram illustrating a prediction and explanation system 200 in accordance with one embodiment of the present invention.

Referring to FIG. 3, the prediction and explanation system 200 may include a preprocessor 210, an embedding vector generator 220, a features concatenator 230, a classifier 240, and an explanation model 250. In some embodiments, the features concatenator 230, the classifier 240, and the explanation model 250 may be implemented with a machine learning (ML) model such as a large language model (LLM).

The preprocessor 210 may receive test failure information associated with test failures for a storage device. The preprocessor 210 may process the test failure information to generate text, categorical and numerical features. In some embodiments, the test failure information includes raw texts from the failure DB 120, log information from the failure DB 120, test labels and numeric values from the failure DB 120.

The preprocessor 210 may include, but is not limited to, a text processor 212, a statistics parser 214, a labels encoder 216 and a value normalizer 218. The text processor 212 may process the raw texts and generate the cleansed text features. The term ‘cleansed’ means ‘more consistent’ with a better quality. The statistics parser 214 may process the log information and generate statistics information as the categorical features associated with affecting the test failures in the storage devices (or other manufactured product being evaluated). The labels encoder 216 may receive the test labels, perform one-hot encoding on the test labels, and generate the numerical features. The value normalizer 218 may normalize the numeric values and generate the normalized values as the numerical features.

The embedding vector generator 220 may receive the text features from the preprocessor 210, and process the text features according to a vector embedding scheme to generate an embedding vector. Vector embeddings are a way to convert words and sentences and other data into numbers that capture their meaning and relationships. The vector embeddings represent different data types as points in a multidimensional space, where similar data points are clustered closer together. These numerical representations are used by the machine learning (ML) models to understand and process this data effectively. The embedding vector generator 220 may be implemented with a large language model (LLM).

The features concatenator 230 may concatenate the embedding vector and the categorical and numerical features, and generate concatenated features as a training dataset

The classifier 240 may classify the training dataset, and generate prediction information indicating probabilities for each category associated with affecting the test failures of the storage device. The classifier 240 may implemented with an ML model. The explanation model 250 may generate explanation information indicating which features have influenced the prediction information.

As described above, the prediction and explanation system 200 may be based on the following: (1) A large language model (i.e., the embedding vector generator 220) is used to generate embeddings for textual information inside the issue tracker 100 (i.e., Jira), for example, an error message, a test name, domain-specific information. (2) Some domain-specific logs are parsed into numerical and categorical features by the statistics parser 214. Then, these features are concatenated with additional numerical features by the features concatenator 230. (3) Embedding vectors are concatenated with other features by the features concatenator 230 and are used to train the classifier 240. (4) The predictions as an output of the classifier 240 are explained to the end user by the explanation model 250. Thus, the prediction and explanation system 200 may be implemented by combining several machine learning approaches for both prediction and explanation. The prediction and explanation system 200 may wait for new issue data from Jira™, access information about the issue from the database and send both predictions and the feature importance to Jira™ for issue tracking.

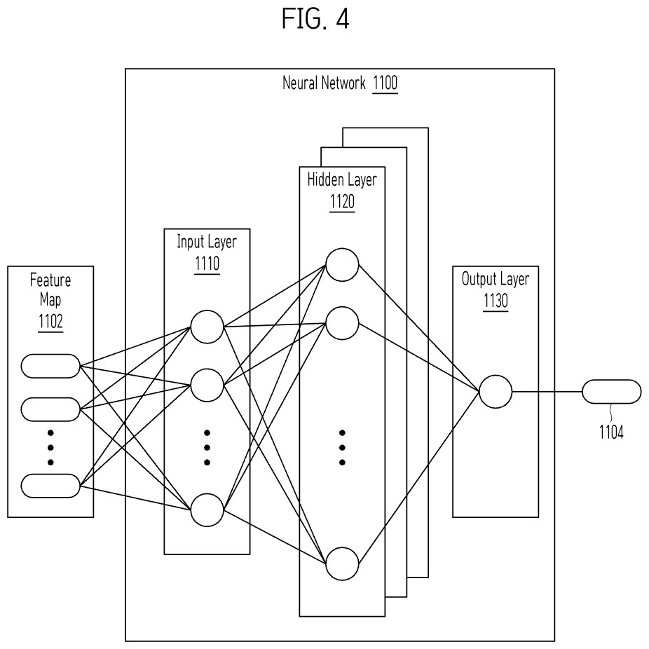

FIG. 4 is a diagram of a neural network 1100 in accordance with one embodiment of the present invention. The neural network 1100 may be a machine learning (ML) model such as large language model (LLM), which can be implemented for the embedding vector generator 220, the features concatenator 230, the classifier 240, and the explanation model 250.

Referring to FIG. 4, a feature map 1102 associated with one or more input conditions may input to the neural network 1100. The feature map 1102 includes one or more features associated with one or more input conditions (e.g., features as an input of the embedding vector generator 220, the classifier 240 and the explanation model 250 in FIG. 3). The neural network 1100 uses the feature map 1102 to generate and output information 1104. As illustrated, the neural network 1100 includes an input layer 1110, one or more hidden layers 1120 and an output layer 1130. Features from the feature map 1102 may be connected to input nodes in the input layer 1110. The information 1104 may be generated from an output node of the output layer 1130. One or more hidden layers 1120 may exist between the input layer 1110 and the output layer 1130. The neural network 1100 may be pre-trained to process the features from the feature map 1102 through the different layers 1110, 1120, and 1130 in order to output the information 1104.

The neural network 1100 may be a multi-layer neural network that represents a network of interconnected nodes, such as an artificial deep neural network, where knowledge about the nodes (e.g., information about specific features represented by the nodes) is shared across layers and knowledge specific to each layer is also retained. Each node represents a piece of information. Knowledge may be exchanged between nodes through node-to-node interconnections. Input to the neural network 1100 may activate a set of nodes. In turn, this set of nodes may activate other nodes, thereby propagating knowledge about the input. This activation process may be repeated across other nodes until nodes in the output layer 1130 are selected and activated.

In one embodiment, the neural network 1100 may include a hierarchy of layers representing a hierarchy of nodes interconnected in a feed-forward way. The input layer 1110 may exist at the lowest hierarchy level. The input layer 1110 as detailed below may include a set of nodes that are referred to herein as input nodes (e.g., features as an input of the embedding vector generator 220, the classifier 240 and the explanation model 250 in FIG. 3). When the feature map 1102 is input to the neural network 1100, each of the input nodes of the input layer 1110 may be connected to each feature of the feature map 1102. Each of the connections may have a weight, each of which is derived from the training of the neural network 1100. The weights represent one set of parameters of the neural network 1100. The input nodes may transform the features by applying an activation function to these features. The information derived from the transformation may be passed to the nodes at a higher level of the hierarchy.

The output layer 1130 may exist at the highest hierarchy level. The output layer 1130 may include one or more output nodes. When the output layer 1130 outputs the output information 1104, each output node may provide a specific value of the output information 1104 (e.g., embeddings vector as an output of the embedding vector generator 220, prediction information as an output of the classifier 240 and explanation information as an output of the explanation model 250, in FIG. 3). The number of output nodes depends on how many specific values of output information 1104 are needed. In other words, there can be a one-to-one relationship or mapping between the number of output nodes and the number of values or pieces of output information 1104.

The hidden layer(s) 1120 may exist between the input layer 1110 and the output layer 1130. There may be L hidden layer(s) 1120, where “L” is an integer greater than or equal to one. Each of the hidden layers 1120 may include a set of nodes that are referred to herein as hidden nodes. Example hidden layers may include up-sampling, convolutional, fully connected layers, and/or data transformation layers.

At the lowest level of the hidden layer(s) 1120, hidden nodes of that layer may be interconnected to the input nodes. At the highest level of the hidden layer(s) 1120, hidden nodes of that level may be interconnected to the output node. The input nodes may be not directly interconnected to the output node(s). If multiple hidden layers exist, the input nodes are interconnected to hidden nodes of the lowest hidden layer. In turn, these hidden nodes are interconnected to the hidden nodes of the next hidden layer. An interconnection may represent a piece of information learned about the two interconnected nodes. The interconnection may have a numeric weight that can be tuned (e.g., based on a training dataset), rendering the neural network 1100 adaptive to inputs and capable of learning. Generally, the hidden layer(s) 1120 may allow knowledge about the input nodes of the input layer 1110 to be shared among the output nodes of the output layer 1130.

Referring back to FIGS. 1 to 3, the prediction and explanation system 200 may perform multiple operations. Initially, the prediction and explanation system 200 may receive a notification that a new failure has occurred, from the issue tracker 100 via the message buffer (queue) 110. After receiving the ID of the new failure, the system 200 may get all available failure information from the failure DB 120. The failure information may be preprocessed by the preprocessor 210. The preprocessor 210 may perform preprocessing by: the text preprocessor 212 for LLM, the statistics parser 214, the labels encoder 216 and/or the value normalizer 218. Preprocessing may be expanded, as new features are included in the prediction process. After that, the preprocessed text features may be encoded by the embedding vector generator (i.e., Large Language Model) 220. The encoded text features may be concatenated with all other features and passed to the classifier (i.e., ML model) 240 and the explanation model 250. The ML model 240 may generate a probability of each category associated with affecting the test failures of the storage device as prediction information, and send the prediction information back to the issue tracker 100. The explanation model 250 may generate explanation information indicating which features have influenced the prediction the most, and may send the explanation information to the issue tracker 100 as well.

Details of the prediction and explanation system 200 are described below.

### Dataset

A dataset may be created for the prediction and explanation system 200 because of the large number of failures with various sources of information that are to be analyzed.

The dataset may include over a million test failures that were reported to Jira™ e.g. over several years. Each test failure has an associated set of information that is to be analyzed:
Text features, such as test stack traces with error messages;
Numerical features such as the test duration or the number of specific events that has happened during the test; and
Labels associated with this test.

Each test failure may be manually attached to the issue tracker 110 (i.e., Jira™ issues) and after that, these Jira™ issues may be analyzed by humans to assign one of N teams. That is, a user may find connection between a test failure and an issue.

The system 200 may be trained to predict this specific label, but a similar approach can be extended to predict other labels that are assigned manually. Despite different supervised learning tasks, this dataset can be used for unsupervised tasks, e.g., for grouping failures into Jira™ issues or for a specific embedding model for error messages. In some embodiments, the predicted labels that are used in the issue tracker and predicted information that is used by the model may be closely connected. During the training process, a predicted label may be converted into probabilities where only one label has probability “1”, and the others are “0.” During prediction process while the model produces probabilities, the probabilities may be converted into a label by choosing the label with the highest predicted probability.

For training purposes, failures may be grouped into Jira™ issues, and all failures associated with a single Jira™ issue may appear in either the training or test dataset. It has been made to neglect data leakage when failures from the same Jira™ issue appear in the training and test dataset. Generally, data leakage means that during the training process, there is information that is not available during prediction. In a specific case, data leakage happens indirectly without this precaution, i.e., if failures from some Jira™ issues appear both in the training and test datasets, a prediction of the category for test failure relies on the failure from the same Jira™ issue with known prediction (that is not possible in real life).

### Embeddings

Almost all of the data may be stored as plain text, so embeddings help to retrieve general high-level features represented as numeric vectors. Large language models can be very useful for text analysis and have proven in general to be effective directly as classifiers.

In some embodiments, the large language models are not used directly for classification, but rather for computing embeddings, because there are additional categorical and numerical features.

Embeddings models, i.e., the embedding vector generator 210, are effective to gather patterns inside texts that are not related to domain-specific knowledge. It is possible to adjust an LLM architecture to accept both numerical and text features, and stronger models can used to achieve better accuracy. Therefore, the embeddings model may be used as the first layer in a stacked model and may be not directly trained.

In one embodiment, text features may be not analyzed separately, because text features are small enough to be concatenated, which saves computational resources. After applying the embeddings model, the next model (i.e., ML model) receives not a variable-length text, but instead receives a fixed-length numerical vector.

### Stacked Models

Embodiments of the present disclosure may provide stacked models in order to achieve best results in the analysis of text, numerical and categorical features.

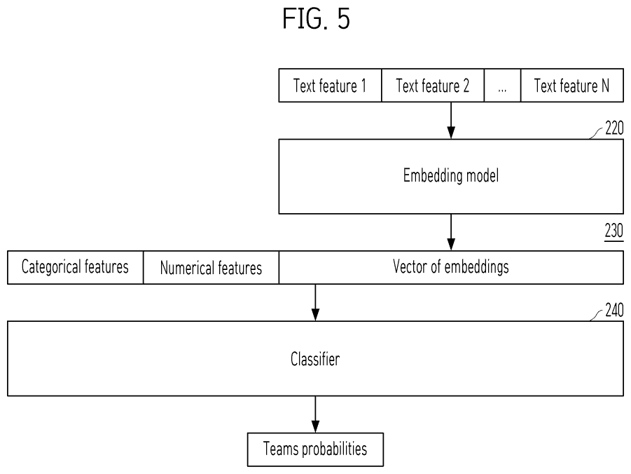

In the illustrated example of FIG. 5, first, text features may be concatenated and processed by the embedding model (i.e., the embedding vector generator 220). For example, N text features are concatenated. The embedding model may convert variable-size texts into a fixed-length numerical vector (i.e., embeddings vector or vector of embeddings). Then, the embeddings vector may be concatenated with a fixed set of categorical and numerical features to get a dataset used for training. That is, the features of concatenator 230 of FIG. 3 may concatenate the embeddings vector with the set of categorical and numerical features to generate the training dataset.

The classifier 240 may train the training dataset using an ML model (e.g., a separate classification model) to achieve the best accuracy. That is, the classifier 240 may classify the training dataset, and generate prediction information indicating probabilities for each category associated with affecting the test failures of the storage device.

### Explanation Method

To build trust in the stacked models among users and validate its reasoning, explanation methods may be used within the failure processing system. The explanation model 250 may generate explanation information indicating which features have influenced the prediction information.

As noted above, the explanation is an important part of the system and complex ML models that are used inside the system. Fortunately, there are approaches that do not depend on one or more particular models and that can measure the importance of different features. Due to fundamental difference between text and numerical features, in one embodiment, this process is divided into two parts:

(1) General game theory approach may be used for categorical and numerical features. As a general explanation of how this approach can be used, this approach can cut off the importance of embeddings. The importance of embeddings can be excluded as embeddings may be analyzed using the similar game theory approach. Using this game theory approach allows estimating how a target category influences the probability of each category for each feature associated with affecting the test failures of the storage device.

(2) A similar game theory approach may be used for text features. Main difference is that the explanation process takes into account strongly connected parts of text. Strong connection may be determined using a complex logic that for examples treats 2 parts of a split word as connected and 2 sentences as 2 separate entities. This additional consideration makes an estimation more accurate. As a result, it is possible to obtain a value of how specific parts of the text influence each category identified by classifier 240.

Finally, it is possible to combine both of these methods to get an explanation for each entry.

The explanation may be a value that is related to the feature and a target category that shows the influence of the feature associated with affecting the test failures of the storage device. In one embodiment, positive values indicate that the presence of the feature increases the probability of the target category, and negative values indicate that the presence of the feature decreases the probability of the target category.

### EXAMPLES

The original dataset may include different failure information regarding each failure in several tables. This dataset may be what the prediction system expects as an input. The only thing that is taken directly from Jira™ is the predicted label. In one example of Table 1 below, the overall dataset size (i.e., the number of failures) is 1629352, which may be divided into training/test subsets as a ratio of 70%/30%, 70%/30% ratio has been applied to Jiras to avoid data leakage. The resulting number of entries may be 1194646 for the training dataset and 434706 for test dataset. In one embodiment, one of N=5 types of failures are predicted that are related to the responsible team (e.g., one Team 1 to Team 5). One example of the division of the predicted classes is shown in Table 1:

TABLE 1

| | Training | Test | Overall |
|---|---|---|---|
| Team 1 entries | 208005 | 93276 | 301281 |
| Team 2 entries | 405459 | 102302 | 507761 |
| Team 3 entries | 7255 | 2648 | 9903 |
| Team 4 entries | 451095 | 180700 | 631795 |
| Team 5 entries | 122832 | 55780 | 178612 |
| Total | 1194646 | 434706 | 1629352 |

Numerical features from the failure database 120 may be preprocessed with a particular logarithm (e.g., the value normalizer 218) to remove large values. Other features may be generated from text entries within the failure database 120 and may require the types of preprocessing as described below.

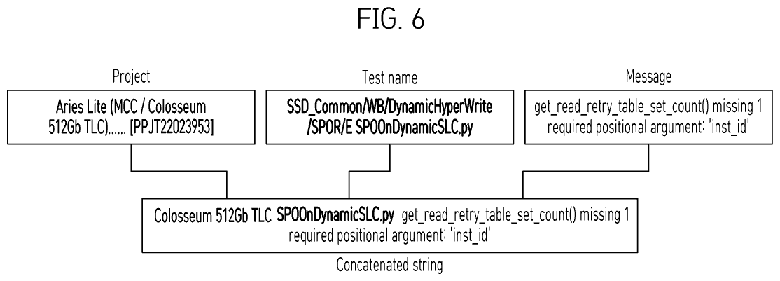

Referring to FIG. 6, for better performance and fewer output features, in one embodiment, all text features (e.g., the project name, the test name, and the data processing message) may be concatenated in a single string. In some embodiments, before the processing of the text features, noise may be removed from the text features.

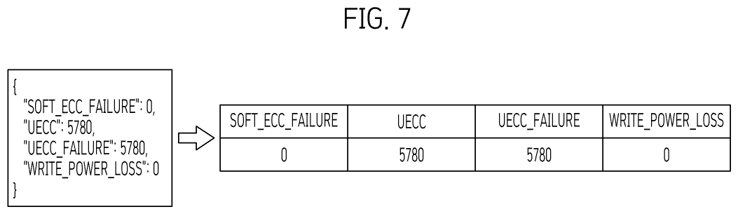

Referring to FIG. 7, some text features may be in a language-independent data format such as JavaScript Object Notation (JSON) format and contain numeric features. These features in JSON format may be parsed, and those numeric values may be passed into the classifier (i.e., ML model). In the example shown in FIG. 7, “SOFT_ECC_FAILURE, 0” is parsed into a numerical value “0” for “SOFT_ECC_FAILURE,” and “UECC_FAILURE, 5780” is parsed into a numerical value “5780” for “SOFT_ECC_FAILURE.”

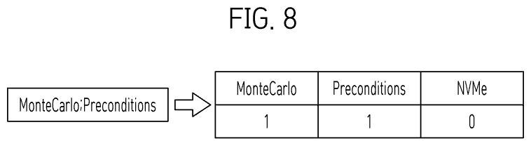

Referring to FIG. 8, test labels may be converted into numerical values using e.g., one-hot encoding. One-hot encoding is a method for converting categorical variables into a binary format. The encoding creates new columns for each category associated with test failure of the storage device (e.g., MonteCarlo, Preconditions, NVMe) where “1” means the category is present and “0” means it is not. The primary purpose of one-hot encoding is to ensure that categorical data can be effectively used in machine learning models.

In some embodiments, using error messages, additional flags may be generated. Such flags may indicate the presence of a specific string in the error messages. This process can be used to validate that model uses it for a specific set of failures.

The inventor of the present disclosure observed that, after previously described preprocessing, 478 features were obtained. All these features were used by the classifier 240 as the training dataset. In some embodiments, the classifier 240 may be implemented with an Extreme Gradient Boost (Xgboost or XGBoost) classifier which is an optimized distributed gradient boosting library. This Xgboost classifier implements machine learning algorithms under the Gradient Boosting framework, and provides a parallel tree boosting and is the leading machine learning library for regression, classification, and ranking problems.

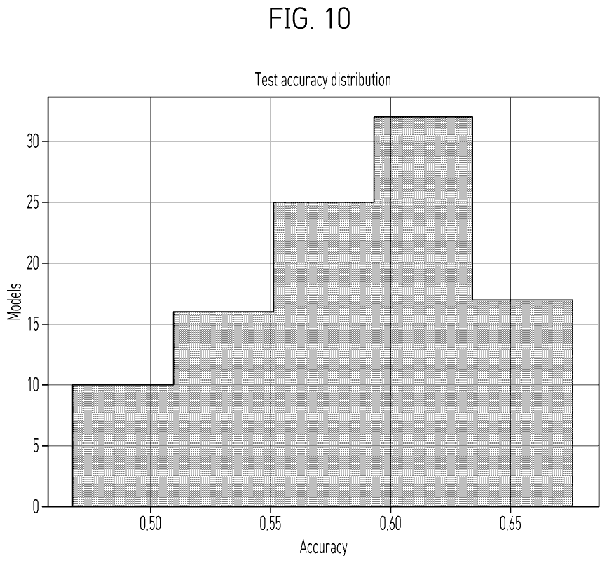

In some embodiments, default hyperparameters are used for the model, as experiments did not show significant improvement for optimized hyperparameters. On the other hand, the experiments showed that failures are diverse and that the results on the test dataset depend on the training/test split. To check this assumption, the whole dataset was divided into the training and test parts with 70%/30% ratio respectively using 100 random seeds. The Xgboost classification model was fitted to the training part and validated on the test part using the accuracy metric. In this check, all accuracy values were gathered together, and the test accuracy distribution was checked as shown in FIG. 10. As shown in FIG. 10, the distribution has a very large interval from 0.5 to 0.65. While additional examples and more features can be used, the available data shows that a 60% accuracy has been achieved on the test dataset and the same average accuracy for 100 test datasets.

In some embodiments, in order to analyze the importance of numeric features, as the explanation model 250, a specific explanation model has been used for tree-based gradient boosting inside a SHapley Additive explanations (SHAP) package. SHAP assigns each feature an importance value for a particular prediction. This approach provides a possibility to analyze aggregated information for a set of failures. This can be helpful for identifying important features not just for a specific failure, but also for a set of failures that are similar in some way, e.g. that are connected to the same Jira™ issue. In the generated importance values, the importance of embeddings is cut off as the importance values cannot be analyzed by a human as is. The final importance plot shows the absolute importance value of a feature for a given class.

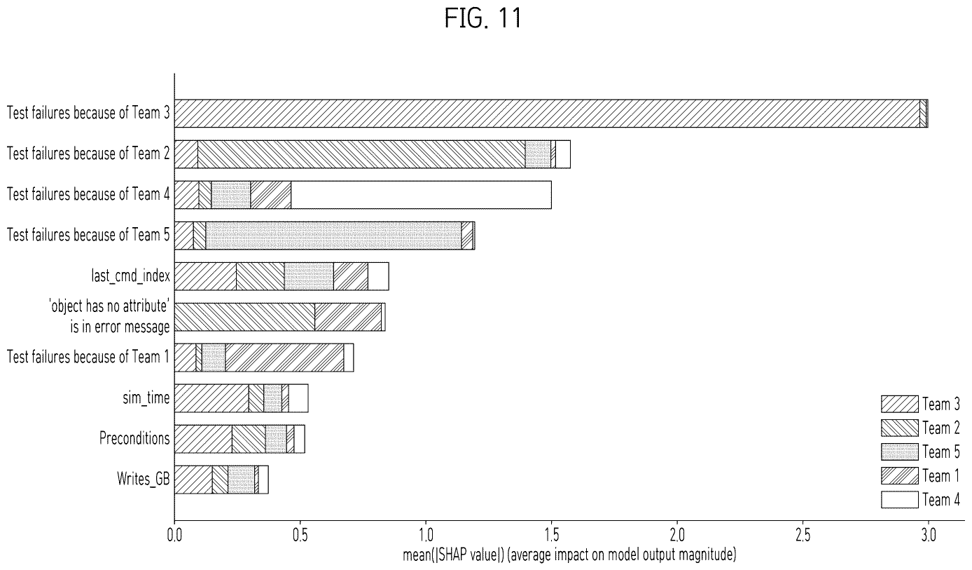

FIG. 11 illustrates aggregated importance of numerical features in a prediction and explanation system in accordance with one embodiment of the present invention.

Referring to FIG. 11, the model finds apparent patterns, but even these apparent patterns prove the reasoning of the model's decision. First, the feature ‘test failures because of Team N’ is strongly related to the category ‘Team N’, which shows that different tests verify the work of different teams. Secondly, the model uses the flag ‘object has no attribute is in error message’ in a subset where all entries have this flag and the distribution of the predicted category for this subset differs from the whole dataset. This fact shows that the model has reasoning, which is intuitive for a human.

Aggregated statistics cannot be used directly for text features, so the importance of tokens as explanation information may be generated for each failure. To get importance values for specific tokens, a partition explainer from the SHAP package may be used as the explanation model 250. The partition explainer masks some tokens and measures the difference in model's predictions, i.e. this approach is model agnostic and can be used with other models. As in the case of numeric features, the importance may depend on the predicted class.

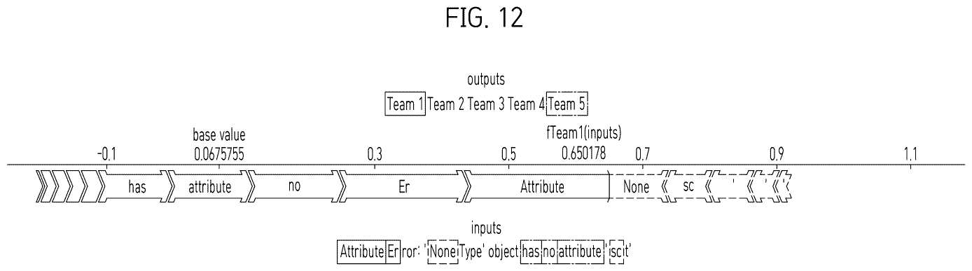

FIG. 12 illustrates the importance of text tokens for Team 1 class in a prediction and explanation system in accordance with one embodiment of the present invention.

Referring to FIG. 12, the illustrated example shows that message parts “AttributeEr” are considered to be important for Team 1 category, because “AttributeError” is likely to happen if someone mistakenly accesses non-existing field in a new Python script. In this case, Team 1 is the one that uses Python the most in their work. Thus, the prediction and explanation system can prioritize some steps in order to find the team to assign a task. In FIG. 12, ‘0.0675755’ is a supposed prediction of ‘Team 1’ probability without text information. ‘0.650178’ is a predicted ‘Team 1’ probability using all text information. The part “None” decreases the probability of category ‘Team 1’. The part ‘Has no attribute’ increases the probability of category ‘Team 1’, and is similar AttributeEr part, because these parts often go together. ‘Team 5’ is the second most probable category as it has high probability, but Team 1 is the most probable.

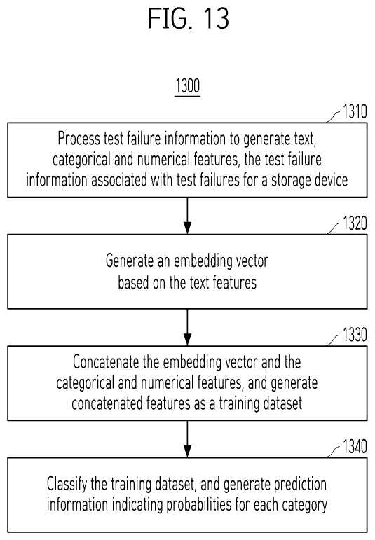

FIG. 13 is a flowchart illustrating a failure processing method 1300 for issue classification of storage devices in accordance with one embodiment of the present invention. The method 1300 may be performed by the prediction and explanation system 200 of FIGS. 1 to 3.

Referring to FIG. 13, at operation 1310, the method 1300 may process test failure information to generate text, categorical and numerical features. The test failure information may be associated with test failures for a storage device (e,g., a SSD). Operation 1320 may generate an embedding vector based on the text features. Operation 1330 may concatenate the embedding vector and the categorical and numerical features, and generate concatenated features as a training dataset. Operation 1340 may classify the training dataset, and generate prediction information indicating probabilities for each category affecting the test failures, the probabilities for each category identifying features to change (optimize) for a reduction in the test failures in the storage device.

In some embodiments, the method further includes generating explanation information indicating which features have influenced the prediction information.

In some embodiments, the test failure information is retrieved from a failure database in response to a failure identifier received from an issue tracker.

In some embodiments, the method further includes providing the prediction information and the explanation information to the issue tracker.

In some embodiments, the test failure information includes raw texts, log information, test labels and numeric values.

In some embodiments, the processing of the processing test failure information includes: processing the raw texts to generate the text features; processing the log information to generate statistics information as the categorical features; performing one-hot encoding on the test labels to generate the numerical features; and normalizing the numeric values to generate the numerical features.

In some embodiments, each text feature includes a project name, a test name, and an error message.

In some embodiments, the text features have a JSON format, and the text features is parsed to generate the numeric features.

In some embodiments, the generating of the embedding vector includes concatenating the text features, and generating a fixed-length numerical vector as the embedding vector.

In some embodiments, the concatenating of the embedding vector and the categorical and numerical features includes concatenating the embedding vector and a fixed set of the categorical and numerical features to generate the training dataset

As described above, embodiments of the present invention provide a scheme for processing failure information for issue classification of a storage device. This scheme can provide prediction information and explanation information associated with test features, categorical features and numerical features of failure information.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives. Furthermore, the embodiments may be combined to form additional embodiments.

What is claimed is:

1. A system comprising:
a preprocessor configured to process test failure information to generate text, categorical and numerical features, the test failure information associated with test failures for a storage device;
an embedding vector generator configured to generate an embedding vector based on the text features;
a features concatenator configured to concatenate the embedding vector and the categorical and numerical features, and generate concatenated features as a training dataset; and
a classifier configured to classify the training dataset, and generate prediction information indicating probabilities for each category affecting the test failures, the probabilities for each category identifying features to change for a reduction in the test failures in the storage device.

2. The system of claim 1, further comprising an explanation model configured to generate explanation information indicating which of the features have influenced the prediction information.

3. The system of claim 2, wherein the test failure information is retrieved from a failure database in response to a failure identifier received from an issue tracker.

4. The system of claim 3, wherein the prediction information and the explanation information are provided to the issue tracker.

5. The system of claim 1, wherein the test failure information includes raw texts, log information, test labels and numeric values.

6. The system of claim 5, wherein the preprocessor includes:
a text processor configured to process the raw texts and generate the text features;
a statistics parser configured to process the log information and generate statistics information as the categorical features;
a labels encoder configured to receive the test labels, perform one-hot encoding on the test labels, and generate the numerical features; and
a value normalizer configured to normalize the numeric values and generate the normalized values as the numerical features.

7. The system of claim 6, wherein each text feature includes a project name, a test name, and an error message.

8. The system of claim 6, wherein the text features have a JavaScript Object Notation (JSON) format, and the text processor parses the text features and generates the numeric features.

9. The system of claim 1, wherein the embedding vector generator receives and concatenates the text features, and generate a fixed-length numerical vector as the embedding vector.

10. The system of claim 8, wherein the features concatenator concatenates the embedding vector and a fixed set of the categorical and numerical features to generate the training dataset.

11. A method for processing failure information for storage devices, the method comprising:
processing test failure information to generate text, categorical and numerical features, the test failure information associated with test failures for a storage device;
generating an embedding vector based on the text features;
concatenating the embedding vector and the categorical and numerical features to generate concatenated features as a training dataset; and
classifying the training dataset to generate prediction information indicating probabilities for each category affecting the test failures, the probabilities for each category identifying features to change for a reduction in the test failures in the storage device.

12. The method of claim 11, further comprising generating explanation information indicating which of the features have influenced the prediction information.

13. The method of claim 12, wherein the test failure information is retrieved from a failure database in response to a failure identifier received from an issue tracker.

14. The method of claim 13, further comprising providing the prediction information and the explanation information to the issue tracker.

15. The method of claim 11, wherein the test failure information includes raw texts, log information, test labels and numeric values.

16. The method of claim 15, wherein the processing of the processing test failure information includes:
processing the raw texts to generate the text features;
processing the log information to generate statistics information as the categorical features;
performing one-hot encoding on the test labels to generate the numerical features; and
normalizing the numeric values to generate the normalized values as the numerical features.

17. The method of claim 16, wherein each text feature includes a project name, a test name, and an error message.

18. The method of claim 16, wherein the text features have a JavaScript Object Notation (JSON) format, and the text features is parsed to generate the numeric features.

19. The method of claim 11, wherein the generating of the embedding vector includes concatenating the text features, and generating a fixed-length numerical vector as the embedding vector.

20. The method of claim 18, wherein the concatenating of the embedding vector and the categorical and numerical features includes concatenating the embedding vector and a fixed set of the categorical and numerical features to generate the training dataset.
